(19) United States
(12) Patent Application Publication
(10) Pub. No.: US 2008/0216176 A1
(43) Pub. Date: Sep. 4, 2008

(54) HARDWARE-ASSISTED ROOTKIT BLOCKER FOR NETWORKED COMPUTERS

(75) Inventors: Chris C. Lomont, Ann Arbor, MI (US); Charles J. Jacobus, Ann Arbor, MI (US)

Correspondence Address: GIFFORD, KRASS, SPRINKLE,ANDERSON & CITKOWSKI, P.C, PO BOX 7021, TROY, MI, 48007-7021, US

(73) Assignee: Cybernet Systems Corporation, Ann Arbor, MI (US)

(21) Appl. No.: 12/026,850

(22) Filed: Feb. 6, 2008

Related U.S. Application Data
(60) Provisional application No. 60/888,331, filed on Feb. 6, 2007.

(51) Int. Cl. H04L 9/00

(52) U.S. Cl. 726/24

(57) ABSTRACT

A hardware-assisted security system for networked computers can detect, prevent, and mitigate rootkits. The solution relies upon an add-on card that monitors the system, alerting administrators when malicious changes are made to a system. The technical detail lies in the techniques needed to detect rootkits, preventing rootkits when possible, and granting administration of protected systems. A beneficial side-effect of the solution is that it allows many other security features, like system auditing, forensic capabilities to determine what happened after an attack, and hardware lock-down of important system resources.

### REFERENCE TO RELATED APPLICATION

This application claims priority from U.S. Provisional Patent Application Ser. No. 60/888,331, filed Feb. 6, 2007, the entire content of which is incorporated herein by reference.

### FIELD OF THE INVENTION

This invention relates generally to blocking malicious code and, in particular, to a hardware-assisted security system for networked computers that can detect, prevent, and mitigate rootkits.

### BACKGROUND OF THE INVENTION

Rootkits are Trojan horses installed by an intruder that mask changes that have been made in a system after attack. They replace or modify intrusion or other system status detecting applications so that they report a properly functioning system to a systems administrator, when in fact, the system has been compromised.

The basic best practice for rootkit detection is to know what applications (and kernel) files are supposed to be installed, and to verify that they have not been changed. This is best done now by scanning an installation against a read-only reference and detection of unwarranted changes. A simpler but less robust method is to check installed applications against their known correct checksum.

If the checking program or its database is available for modification by an intruder, the check program itself can be compromised. Furthermore, all security related database or parameter files or records must be validated against some external specification. Since configuration is often not stored redundantly, and with one set securely read-only, subtle configuration changes due to an intruder can be difficult to detect.

Newer rootkits are much smarter, and some are only memory resident, living on the network. Thus, offline file scanning tools are not good enough to detect them. Furthermore, newer “fourth generation” rootkits, on x86 architectures (and probably elsewhere), use hardware ticks to hide from memory scanners by being able to move when their addresses are scanned for infection.

### SUMMARY OF THE INVENTION

This invention resides in a hardware-assisted security system for networked computers that can detect prevent, and mitigate rootkits. The solution relies upon an add-on card that monitors the system, alerting administrators when malicious changes are made to a system. The technical detail lies in the techniques needed to detect rootkits, preventing rootkits when possible, and granting administration of protected systems. A beneficial side-effect of the solution is that it allows many other security features, like system auditing, forensic capabilities to determine what happened after an attack, and hardware lock-down of important system resources.

### BRIEF DESCRIPTION OF THE DRAWINGS

FIG. 1 shows a block diagram of the preferred embodiment of the invention.

### DETAILED DESCRIPTION OF THE INVENTION

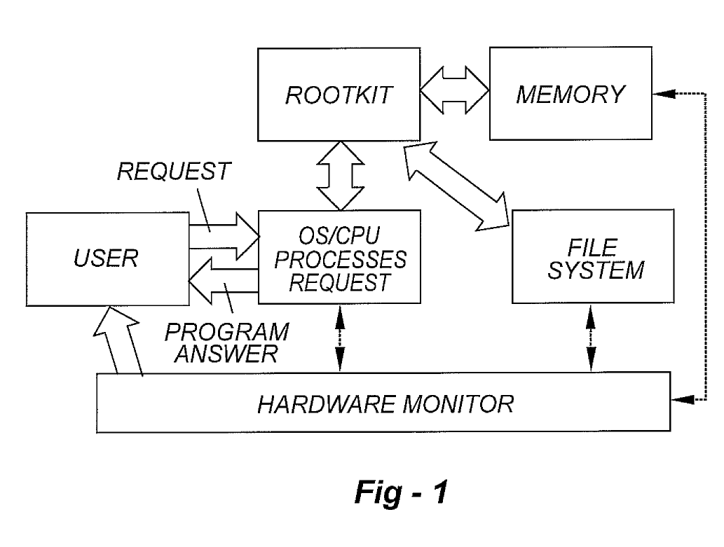

A block diagram is in FIG. 1. A low-cost PCI-Express add-on card that provide a second processor, physically isolated from attackers that can detect malware on the host machine. This hardware monitor card can intercept network traffic, monitor and intercept hard drive traffic, and analyze host memory in order to find malware, log accesses, and prevent intrusion. If the card can scan physical memory without help from the host OS, further advantages may be realized.

### Hardware Details

### Hard Drive Scanner/Controller.

This may be implemented similar to hard drive controller cards, with the feature of being able to initiate reading files, sectors, and raw hard drive data at will. System hard drives will pass through the card; thus, the card needs to be fast. At present, an ATA or SATA generic interface should be used. If hard drive sector locking is enabled, changes may be prevented to sectors where it is known that files should not change, like the boot sector and system files. In either case this may be software selectable so the user can perform system maintenance.

### Memory Scanner.

The card should be able to read all of physical memory, scanning it without host PC intervention. This is not possible under a standard PCI interface specification. However, this should be possible under PCI-Express, and if it is not, host help in dumping memory may be invoked. This opens up spoofing attacks by the rootkit, but these will be combated with methods explained below under the card software section. The card should have a decent amount of RAM (512 MB or 1 G) to quickly gather an accurate snapshot.

### Network Pass-Through.

In order to allow secure remote administration, the card has to be on the network that the host is on. This way malware on the host cannot modify administrative commands sent to the card. If there is a pass through, the card also has the option of monitoring all network traffic to and from the card, which would be useful for detection/prevention of malware and for forensic data gathering. So the card should have at least two Ethernet ports on it. A variant of SSH and a packet filter will allow the card to pull out packets designated as control from the packet stream, so the host has no idea it is under surveillance.

### USB Port.

A USB Port allows physical setting of initial system parameters to ease deployment in enterprise environments, allows a boot CD based administrative tool for secure passing of commands to the card, and allows single user administration without requiring network administration.

### Program Execution.

The card should be able to send programs to the host for execution. If the host has a rootkit, the rootkit cannot analyze arbitrary code sent to it to determine how to answer; this becomes the Halting problem. The strength of sending even user-mode programs to the system is the card can change the programs easily, and the rootkit would have little idea how to fake the results. The host driver allowing this should be optional to the system so the card can be run with no chance of the OS or possible rootkits knowing they were being monitored. This is a low priority item, but could enable some security checking.

As a result of these requirements, the following hardware would be acceptable:

### RAM.

Space needs to be determined from a price/performance ratio. 512 MB or 1 GB would be preferred, although 64 MB would be sufficient at the cost of capturing host RAM dumps quickly and accurately for larger host RAM sizes. The larger the RAM, the faster and less invasive the malware detection/prevention system will be on the host.

### Speed.

The card needs enough speed to hash files and scan memory at an appropriate speed, resulting in <5% host performance hit, The faster the system, the lower the performance. though heat generation should be considered. As such, something similar in power to P4 1 GHZ or greater, if possible.

### Storage.

The card will need a hard drive (or large flash area) of its own to store file checksums and memory snapshots for analysis. 2 MB of card storage for each 1 GB of hard drive space on the host drive should be enough for each snapshot, so for a 200 GB user drive (forward looking), and storing a few hashes as differences, means that 512 MB or 1 G of hard storage should be enough for data for a few snapshots. If the card has a small notebook hard drive on it, 20-40 GB would be excellent. A memory snapshot is as large as the host RAM size; so a few GB might be needed since this card will go in servers. The program running the card will need to be upgradeable, so it will be stored in flash or on the card hard drive.

### Software Details

### Hardware Card Software.

This will be a straightforward implementation in portable C/C++. For the OS specific routines, the necessary items will be extracted. The most difficult tasks in decreasing order of complexity will be as follows:

### Memory Scanning.

This will search memory dumps and look for errant behavior. If PCI-Express cannot directly read RAM, an OS based driver will send RAM to the card, allowing rootkit attacks. To help prevent this other techniques may be used such as dynamic driver naming, recompiling the driver often internally using a randomized compiler we investigated (makes the binary change), and other tricks to hide the driver from rootkits. A group of algorithms needed to traverse Windows memory images without host support (since rootkits subvert system calls), has already been implemented. All the internal Windows structures may be reconstructed as needed from a raw memory dump.

### Network Protocol.

A secure network protocol, probably based on SSH, hides administration traffic from the host.

### File Scanning.

The rootkit cannot attack the file scanner base, and a Linux based card can read (but not write) all flavors of Windows drive formats easily (NTFS, FAT32, etc). Since the common MD5 and SHA-1 are considered insecure, Whirlpool will be used for testing.

### Administration Software

With respect to the administrator interface, since two IP addresses per computer (for enterprise customers) are undesirable, the card should be transparently (to the host) configurable from the administrator console. Some variant of SSH may be used for this task.

Some of the basic administration areas to be supported include:
1. Analyze—this analyzes a single machine data or correlates machine data for threat tracking, forensics, and basic daily views of an enterprise security.
2. Reports—generates periodic reports and what to do with them: store, email, summarize, etc.
3. Templates—basic templates that can be stored to apply to machines as they are added to the system.
4. Machine manager—single machine management.
5. Communication—passwords, protocols, etc., for the secure HASSM network.
6. Domain manager—manage machines in groups
7. Updates—apply patches and updates to the HASSM from a central place
8. Scheduler—set times for actions such as audits, logs, etc to be performed and maintained.

### Bootable CD Version

A final version of the above ideas, not requiring an add-on PCI card, but requiring physically rebooting the machine, facilitates the use of a boot CD with the appropriate tools. The CD software would save snapshot of relevant file (but not host memory images) info to a USB dongle, where the CD software would compare before and after system images. This would be a scaled-down version of the toolset, but with many of the benefits for detecting system changes.

We claim:

1. A hardware-assisted rootkit blocker that protects a host machine on a computer network, comprising:
an add-on card with hardware and software that performs the following functions:
a) monitors the host machine, and
b) alerts administrators if malicious changes are made to the host.

2. The hardware-assisted rootkit blocker of claim 1, wherein the add-on card is a PCI-Express card.

3. The hardware-assisted rootkit blocker of claim 1, wherein the add-on card includes a physically isolated processor operative to detect malware on the host machine.

4. The hardware-assisted rootkit blocker of claim 1, wherein the add-on card is operative to monitor and intercept network traffic to or from the host machine.

5. The hardware-assisted rootkit blocker of claim 1, wherein the add-on card is operative to monitor and intercept hard drive transfers on the host machine.

6. The hardware-assisted rootkit blocker of claim 1, wherein the add-on card is operative to analyze host memory, in order to find malware, log accesses, and prevent intrusion.

7. The hardware-assisted rootkit blocker of claim 1, wherein the add-on card is operative to scan physical memory on the host machine without help from the host operating system.

8. The hardware-assisted rootkit blocker of claim 1, wherein:
the add-on card is operative to send code to the host machine for execution; and
issue an alert if the host machine is unable to execute the code.
